(19) United States
(12) Patent Application Publication
(10) Pub. No.: US 2022/0296048 A1
(43) Pub. Date: Sep. 22, 2022

(54) Safe Food Transport and Serving Apparatus

(71) Applicants: Seth Gold, Raleigh, NC (US); Graham Howard, Raleigh, NC (US)

(72) Inventors: Seth Gold, Raleigh, NC (US); Graham Howard, Raleigh, NC (US)

(21) Appl. No.: 17/701,613

(22) Filed: Mar. 22, 2022

Related U.S. Application Data
(60) Provisional application No. 63/164,262, filed on Mar. 22, 2021.

(51) Int. Cl. A47J 47/14; A47J 36/24

(52) U.S. Cl. CPC A47J 47/14; A47J 36/2483

(57) ABSTRACT

The present invention is an apparatus for both securely transporting and hygienically serving warmed food. The instant innovation includes stackable and connectable insulated containers capable of being opened from the top and at least one side. Each insulated container may contain an electrical heating element to warm foodstuffs placed within the container. The instant innovation limits exiting loci for incidents of food-transport related mess, heat loss, and adulteration.

### RELATED APPLICATIONS

This application claims the priority benefit of Provisional Application No. 63/164,262 filed on Mar. 22, 2021, the entire contents and disclosures of which are incorporated herein by reference.

### FIELD OF THE INVENTION

The present invention relates to the secure storage, transporting and serving of warmed food. Specifically, the present invention provides for stackable and connectable insulated containers capable of being opened from the top and at least one side.

### BACKGROUND

Transporting prepared food from a kitchen or other cook area to a distant eating site creates unique challenges for both the professional caterer and the amateur chef. Food intended to be served warm must be kept warm in transit, excepting only if it is warmed on site. In either instance however, once the food arrives where it is to be eaten it must be kept warm, sanitary, and appealing during food service.

Often, chefs load prepared foods into chafing dishes that are then covered with plastic or foil food wraps to minimize spilling and adulteration. Chefs may place several laden chafing dishes into portable insulated containers in which food is transported to a food service site. Upon arrival at its destination, servers who seek to extend the period of food service commonly remove the chafing dishes from the portable insulated containers, insert the chafing dishes into free-standing chafers, and maintain the food temperature by using a chemical flame or other heat source placed below each chafing dish. Each point at which the food transported is uncovered or uninsulated serves as a locus for food mess and adulteration as well as heat loss.

In the light of the above given information, nowadays, the way of having a convenient way of securely transporting food items that are intended to be served warmed, is an important problem to be solved. Accordingly, embodiments of the invention, provide significant advantages while overcoming the above-described and other disadvantages, as will now be described.

### SUMMARY

This summary is provided merely for purposes of summarizing some example embodiments, so as to provide a basic understanding of some aspects of the subject matter described herein.

An apparatus for food containment, is disclosed. The apparatus includes a plurality of insulated compartments. The plurality of insulated compartments are stacked one upon the other. The plurality of insulated compartments comprises of a first insulated compartment and a second insulated compartment slidably connected to each other. The apparatus includes a plurality of top covers, configured to cover each of the plurality of insulated compartments, wherein the plurality of top covers are each configured to be folded up in an open position, and folded down in a closed position. The apparatus includes a plurality of heating elements retained within each of the plurality of insulated compartments. The apparatus includes a controller configured to receive one or more inputs setting a temperature to be applied to one or more of the plurality of heating elements.

In one embodiment, each of the plurality of insulated container may stand unconnected to each of the other plurality of insulated containers.

In one embodiment, each of the plurality of insulated container may stand unconnected to each of the other plurality of insulated containers.

In one embodiment, the plurality of top covers comprise of a plurality of panels, each of the plurality of panels configured to fold one upon the other in an open position.

In one embodiment, the closed position of each of the plurality of panels is configured to maintain the predetermined temperature within a covered compartment, and retain the position of contents within the covered compartment.

In one embodiment, each compartment is configured to retain one or more retaining devices configured to retain contents within the compartment.

In one embodiment, the controller comprises of one or more switches operably connected to one or more heating elements in the plurality of insulated compartments.

In one embodiment, one or more indicator lights configured to indicate one or more of a temperature setting or an on or off status.

In one embodiment, one or more of the plurality of heating elements are positioned within a bottom panel of each of the plurality of insulated containers.

In one embodiment, each of the plurality of insulated containers comprise of a power source including one or more of a power supply or a battery.

In one embodiment, each of the plurality of insulated containers comprise of a separate electrical receptacle provide the connection to the power supply for purposes of directly powering heating elements and/or charging the battery.

In one embodiment, each of the heating elements are configured to directly contact a retaining device retaining contents, or separated from the retaining device by a heat-conductive surface or membrane.

In one embodiment, a topmost insulated container comprises of one or more supports configured to extend from a bottom of the top most insulated compartment when in the open position.

In one embodiment, topmost insulated container is configured to slide back on one or more rails, extending the one or more supports, and configured to provide access to a lower container, wherein each of the top most insulated container and the lower container are in an open position.

Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DESCRIPTION OF THE DRAWINGS

Certain illustrative embodiments illustrating organization and method of operation, together with objects and advantages may be best understood by reference to the detailed description that follows taken in conjunction with the accompanying drawings.

Additionally, some embodiments of the present invention are illustrated as an example and are not limited by the figures of the accompanying drawings, in which like references may indicated similar elements and in which:

FIG. 1 is a view of an embodiment of the apparatus in a closed position consistent with certain embodiments of the present invention;

FIG. 2 is a first view of an embodiment of the apparatus in an open position consistent with certain embodiments of the present invention;

FIG. 3 is a second view of an embodiment of the apparatus in an open position consistent with certain embodiments of the present invention;

FIG. 4 is a third view of an embodiment of the apparatus in an open position consistent with certain embodiments of the present invention;

FIG. 5 is a view of an embodiment of the apparatus in a partially open position consistent with certain embodiments of the present invention; and

FIG. 6 is a view of a heat-conductive interface consistent with certain embodiments of the present invention.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

The invention may be embodied in other specific forms without departing from the spirit of essential characteristics thereof. The present embodiments therefore to be considered in all respects as illustrative and not restrictive, the scope of the invention being indicated by the appended claims rather than by the foregoing description, and all changes which come within the meaning and range of equivalency of the claims are therefore intended to be embraced therein.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The following description is not to be taken in a limiting sense but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The preferred embodiment herein described is not intended to be exhaustive or to limit the invention to the precise form disclosed. It is chosen and described to explain the principles of the invention and its application and practical use to enable others skilled in the art to follow its teachings.

Although the food service industry has created numerous innovations intended to ease the work of food servers while increasing the culinary pleasures of the food itself, there remains a need for an apparatus to contain and keep multiple segregated foodstuffs warm and sanitary both during transport and service, while simultaneously permitting a server to easily access each such segregated food item. Equally important, for those home chefs, weekend parties, and family occasions, a segregated food apparatus may be used to transport foods prepared at one location to another location while keeping the food both contained and permitting the food to be heated and served readily and easily in a multi-compartment food transport apparatus.

In an embodiment, the instant innovation is a device designed to hold food wholly within its main body and to keep the food warm by using an incorporated electric heating element. Such electric heating element may be powered by regular household alternating current via an outlet (whether or not via use of an A/C adapter), through a connection to a portable generator, or it may be powered via battery.

In an embodiment the instant innovation includes a multi-compartment food containment apparatus having one or more housings for the containment and reheating of food items placed within a housing. Each housing is designed to surround a central void into which foodstuffs may be placed, the housing being capable of at least one open and one closed position. When a housing is in the closed position the void is air-tight and is insulated against heat loss. In use each housing is closed prior to transport and thereby may keep foodstuffs placed within each void hot, contained, and unadulterated during transit.

In an embodiment the instant innovation presents a multi-compartment food containment apparatus that includes at least two segregable containers each characterized by an interior void. The containers may be placed in a layered configuration, one compartment being placed on top of another compartment in a vertical arrangement. One or more compartments may be arranged above subordinate layered compartments and are positioned, configured and connected so as to be capable, while fully laden, of sliding in at least one linear dimension one upon the other.

In an embodiment, an upper compartment positioned vertically above a lower compartment may be connected to the lower compartment by a sliding rail on each side of the bottom portion of the upper compartment. The sliding rails permit the upper compartment to slide over the top of the lower compartment, completely covering the top surface of the lower compartment yet positioned such that the weight of the upper compartment is supported by the sliding rails. In use, the upper compartment may be pushed back from the top of the lower compartment to expose a lid in the top portion of the lower compartment. When pushed back on the sliding rails, the upper compartment slides back far enough to permit the opening of the lid in the top portion of the lower compartment to provide access to any items, foodstuffs or other items, that are stored in the void in the lower compartment. When not in use, and for transport, the upper compartment may slide over the top of the lower compartment once again to completely cover the top surface of the lower compartment.

The top compartment may also comprise a lid in the top surface of the upper compartment. The lid may open to permit access to foodstuffs or any items stored in the void in the upper compartment. The lid of the upper compartment may be locked for transport, and may be openable at any time it is not locked in place. Additionally, the upper compartment may have one or more supports that extend from the bottom of the upper compartment when the upper compartment is pushed back on the sliding rails from the top of the lower compartment. The supports extend from the bottom of the upper compartment to the surface upon which the multi-compartment food containment apparatus is positioned to provide support for the weight of the upper compartment and to prevent tipping when the upper compartment is pushed fully back on the rails and the lower compartment is accessible. When fully pushed back on the rails both the upper compartment and the lower compartment of the multi-compartment food containment apparatus are accessible, with both lids capable of being opened fully to provide access to all foodstuffs and other items stored within the apparatus.

The top lid forming a portion of the top of each compartment may be sealable, may be unsealed and lifted, and in certain embodiments removed, and a sealable front gate that may fold down or otherwise be removed. In either case the lifting, folding down, or removal permits access to the contents of the compartment to which the lid is attached. In an embodiment, a user may easily slide food or other items into and remove any items from any compartment when the lid is unsealed and open. The user may have unfettered simultaneous access to each layered compartment while the food to be served is kept warm for an extended amount of time.

In an embodiment the instant innovation is easily transported and has a built-in battery powered heating element suitable for keeping food warm for an extended amount of time. The instant innovation is capable of combining the attributes of a food carrier and serving container.

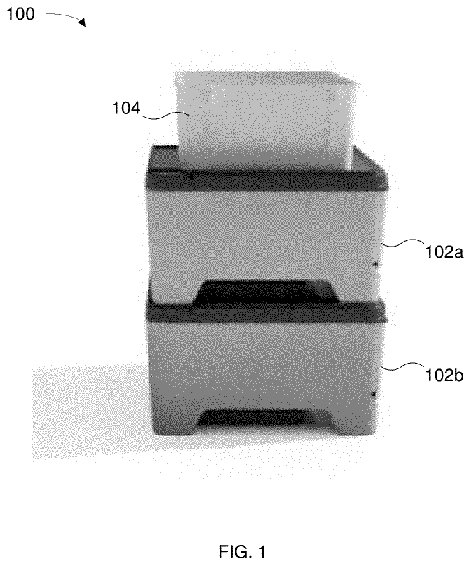

Turning now to FIG. 1, a view of an embodiment of the multi-compartment food containment apparatus 100 in a closed position consistent with certain embodiments of the present invention is shown. In the embodiment, the apparatus 100 includes two closed, insulated compartments 102a-102b, herein referred to as containers, stacked one upon the other. Although in an embodiment each container 102a-102b is insulated and is capable of being slidably connected to the other, in an embodiment each insulated container 102a-102b may stand unconnected to other containers. A number of empty nested containers capable of holding silverware or the like is shown stacked upon the topmost closed, insulated container 104.

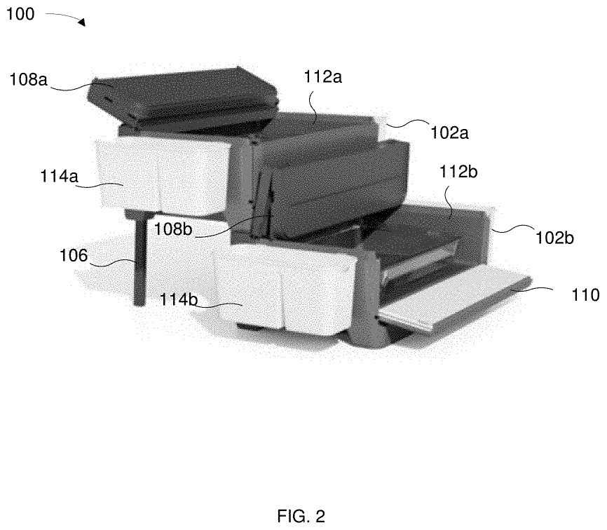

Turning now to FIG. 2, a first view of an embodiment of the apparatus in an open position consistent with certain embodiments of the present invention is shown. In the embodiment 200, the topmost insulated container 102a is shown as having been slid a distance roughly equal to the depth of the top cover of the bottommost insulated container 102b. In the embodiment the front edge of the topmost insulated container 102a is supported by the rear edge of the bottommost insulated container 102b and the rear edge of the topmost insulated container 102a is supported by one or more hinged or otherwise articulable support legs 106. Each of the insulated containers 102a-b may have a top cover 108a-b to close the top portion of the insulated container 102a-b, and a hinged front cover 110 to provide access to the void in the insulated container 102a-b through a more convenient front opening to the insulated container 102a-b. The topmost insulated container is shown with its top cover 108a folded in accordion fashion to permit access to the interior void 112 of the topmost insulated container 102a. The bottommost insulated container 102b is shown with its top cover 108b folded in accordion fashion and its hinged front cover 110 folded down along its hinge to permit access to the interior void 112b of the bottommost insulated container 102b. When closed each accordioned top cover for each insulated container 102a-b permits the sealing of the insulated container 102a-b against temperature change and movement of the items or foodstuffs within the insulated container 102a-b so as to keep the foodstuffs or other items wholly contained and at a desired temperature.

In this embodiment, side compartments 114a-b that are attached to, but separable from each insulated container 102a-b, may be utilized with the insulated containers 102a-b to hold additional items such as condiments, utensils, party favors, or any additional materials that may be required during the utilization of the multi-compartment food containment apparatus 100.

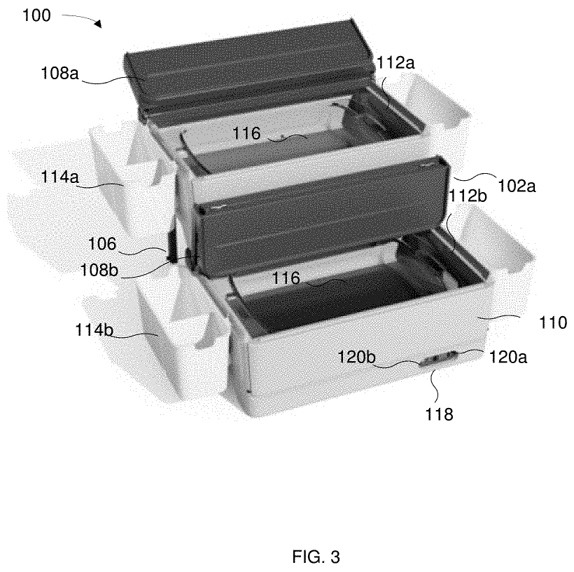

Turning now to FIG. 3, a second view of an embodiment of the front orientation of the multi-compartment food containment apparatus during use in an open position consistent with certain embodiments of the present invention is shown. In this embodiment 300 the empty side compartments 114a-b are more visibly connected to each end of each insulated containers 102a-b. The bottommost insulated container 102b is shown with its top cover 108b folded in accordion fashion to permit access to the interior void of the bottommost insulated container, but with its hinged front cover in a closed position. Visible as resting within each interior void 112a-b of each insulated containers 102a-b is, by way of non-limiting example, a casserole dish 116.

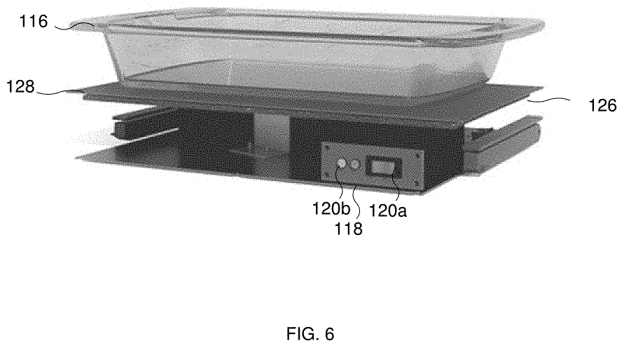

Shown along the bottom front edge of the bottommost insulated container is a controller 118 including a switch and one or more indicator lights. The switch and indicator lights are operably connected to one or more heating elements (refer to FIG. 6). The one or more heating elements may be housed within the bottom panel of any insulated container 102a-b and are designed to heat the contents of the insulated container above ambient temperature when in operation.

In one embodiment, the switch 120a and indicator lights 120b are configured to be operated by the controller 118. The controller is configured to be analog or digital, and in communication with the one or more heating elements. The controller 118 is configured to set one or more inputs for each of the one or more heating elements to have an on/off indication, one or more temperature settings, and a temperature gauge.

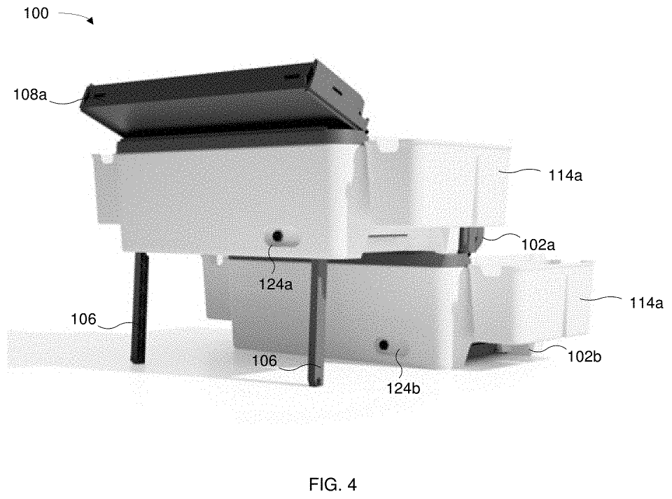

Turning now to FIG. 4, a third view of an embodiment of the rear orientation of the multi-compartment food containment 100 in an open position consistent with certain embodiments of the present invention is shown. In the embodiment 100 may be seen, along the bottom rear edge of each insulated container 102b, an electrical receptacle 124a-b for receiving a power cord. Each insulated container portion of the apparatus 100 may have a separate electrical connection so as to provide heating to only those insulated containers 102a-b that require an elevated temperature. Each electrical receptacle 124a-b is operably connected to one or more heating elements (not shown). In an embodiment the electrical receptable may provide the connection to a power supply for purposes of directly powering heating elements and/or charging an interior battery (not shown).

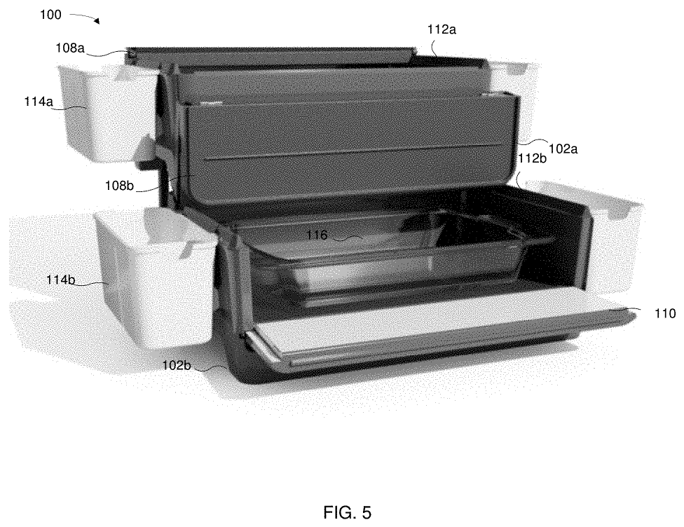

Turning now to FIG. 5, a view of an embodiment of the multi-compartment food containment apparatus 100 in a partially open position in a forward vantage point consistent with certain embodiments of the present invention is shown. Embodiment 500 is shown with the top cover 108a of the topmost insulated container 102a removed entirely from the apparatus with the front hinged portion upright and in place. The figure also shows the top cover of the bottommost insulated container 102b folded in accordion fashion and its hinged front cover 110 folded down along its hinge to permit access to the interior void of the bottommost insulated container 112b.

Turning now to FIG. 6, a view of a heat-conductive interface 116 consistent with certain embodiments of the present invention is shown. At embodiment 600, a casserole dish 116 rests on top of a heat source. In the embodiment the heat source may include a heating element 126 operably connected to a switch 120a, one or more indicator lights 120b, and an electrical power source. In an embodiment the heating element may be positioned to come into direct contact with the casserole or other dish 116, or the food itself. In an embodiment the heating element may be separated from the dish or food by a heat-conductive surface or membrane 128.

While certain illustrative embodiments have been described, it is evident that many alternatives, modifications, permutations and variations will become apparent to those skilled in the art in light of the foregoing description

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

Although the present invention has been described in terms of various embodiments, it is not intended that the invention be limited to these embodiments. Modification within the spirit of the invention will be apparent to those skilled in the art.

It is additionally noted and anticipated that although the device is shown in one form, various components and aspects of the device may be differently shaped or modified when forming the invention herein. As such those skilled in the art will appreciate the descriptions and depictions set forth in this disclosure or merely meant to portray examples of preferred modes within the overall scope and intent of the invention and are not to be considered limiting in any manner.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. An apparatus for food containment comprising:
a plurality of insulated compartments, wherein:
each of the plurality of insulated compartments are stacked one upon the other; and
the plurality of insulated compartments comprises of a first insulated compartment and a second insulated compartment slidably connected to each other;
a plurality of top covers, configured to cover each of the plurality of insulated compartments, wherein the plurality of top covers are each configured to be folded up in an open position, and folded down in a closed position;
a plurality of heating elements retained within each of the plurality of insulated compartments; and
a controller configured to receive one or more inputs setting a temperature to be applied to one or more of the plurality of heating elements.

2. The apparatus of claim 1, wherein each of the plurality of insulated container may stand unconnected to each of the other plurality of insulated containers.

3. The apparatus of claim 1, wherein each of the plurality of insulated container may stand unconnected to each of the other plurality of insulated containers.

4. The apparatus of claim 1, wherein the plurality of top covers comprise of a plurality of panels, each of the plurality of panels configured to fold one upon the other in an open position.

5. The apparatus of claim 4, wherein the closed position of each of the plurality of panels is configured to:
maintain the predetermined temperature within a covered compartment; and
retain the position of contents within the covered compartment.

6. The apparatus of claim 1, wherein each compartment is configured to retain one or more retaining devices configured to retain contents within the compartment.

7. The apparatus of claim 1, wherein the controller comprises of:
one or more switches operably connected to one or more heating elements in the plurality of insulated compartments; and
one or more indicator lights configured to indicate one or more of a temperature setting or an on or off status.

8. The apparatus of claim 1, wherein one or more of the plurality of heating elements are positioned within a bottom panel of each of the plurality of insulated containers.

9. The apparatus of claim 1, wherein each of the plurality of insulated containers comprise of a power source including one or more of a power supply or a battery.

10. The apparatus of claim 9, wherein each of the plurality of insulated containers comprise of a separate electrical receptacle provide the connection to the power supply for purposes of directly powering heating elements and/or charging the battery.

11. The apparatus of claim 1, wherein each of the heating elements are configured to directly contact a retaining device retaining contents, or separated from the retaining device by a heat-conductive surface or membrane.

12. The apparatus of claim 1, wherein a topmost insulated container comprises of one or more supports configured to extend from a bottom of the top most insulated compartment when in the open position.

13. The apparatus of claim 12, wherein topmost insulated container is configured to slide back on one or more rails, extending the one or more supports, and configured to provide access to a lower container, wherein each of the top most insulated container and the lower container are in an open position.
